(19) United States
(12) Patent Application Publication
(10) Pub. No.: US 2026/0128242 A1
(43) Pub. Date: May 7, 2026

(54) BUTTON STRUCTURE

(71) Applicant: CHENG UEI PRECISION INDUSTRY CO., LTD., New Taipei City (TW)

(72) Inventor: TSUNG-SHIH LEE, New Taipei City (TW)

(21) Appl. No.: 19/198,070

(22) Filed: May 4, 2025

(30) Foreign Application Priority Data
Nov. 7, 2024 (CN) 202422706849.2

(51) Int. Cl. H01H 13/18; A63F 13/24; H01H 1/58

(52) U.S. Cl. CPC H01H 13/186; H01H 1/5805; A63F 13/24

(57) ABSTRACT

A button structure includes a button body, a conductive film, a circuit board, a metal elastic element and a bracket. The button body has a pressing portion. One side of an upper portion of a rear surface of the pressing portion protrudes upward to form a protruding pillar. A middle of the upper portion of the rear surface of the pressing portion extends rearward to form a triggering portion. The conductive film is disposed to an inner surface of the pressing portion, and the conductive film surrounds the protruding pillar. The circuit board has a switch corresponding to the triggering portion. One end of the metal elastic element is mounted around the protruding pillar together with the conductive film. The other end of the metal elastic element is fastened to the circuit board. The bracket is disposed to the rear of the button body.

### CROSS REFERENCE TO RELATED APPLICATIONS

The present application is based on, and claims priority from, China Patent Application No. 202422706849.2, filed Nov. 7, 2024, the disclosure of which is hereby incorporated by reference herein in its entirety.

### BACKGROUND OF THE INVENTION

### Field of the Invention

The present invention generally relates to a button structure, and more particularly to a button structure having a better usage hand feeling and a touch sensing function.

### Description of Related Art

Generally, shoulder keys in a game controller are acted as more frequently used operating keys. The shoulder keys are symmetrically disposed to two opposite sides of a front end of the game controller. The shoulder keys are pressed by index fingers to operate the game controller. The shoulder keys are rebounded to be restored to original positions by resilience forces of the shoulder keys and structure strengths of the shoulder keys. A length of each shoulder key is relatively longer, and a production tolerance and an assembling tolerance are generated between the shoulder keys and other various structures of the game controller, so a distance is formed between the shoulder keys and an electronic component of the game controller when the shoulder keys are pressed downward, and a larger gap is formed between a contacting point of each shoulder key and the electronic component of the game controller. As a result, the shoulder keys have a poor usage hand feeling.

A conventional game pad includes a button assembly, a switch assembly and a button bracket. The switch assembly is disposed to the button bracket. The switch assembly and the button assembly are cooperated with each other. The button assembly has a shaft. The button bracket has a button fixing structure. A shape of the button fixing structure is matched with a shape of the shaft. The shaft is buckled in the button fixing structure, so that the button assembly is rotatably connected with the button bracket.

However, when the button assembly and the switch assembly are assembled, the button assembly and the switch assembly are cooperated with a zero tolerance, the button assembly and the switch assembly are overly pressed easily. The button assembly is rotatably connected to the button bracket. When the button assembly is pressed downward, different forces are required at the time of pressing different positions of a button body of the button assembly, and a tilt of the button body is caused, so a usage hand feeling is affected. In addition, the button assembly of the conventional game pad lacks a touch sensing function for detecting an approaching finger.

Thus, it is essential to provide an innovative button structure, and the button structure has a better usage hand feeling and a touch sensing function.

### BRIEF SUMMARY OF THE INVENTION

An object of the present invention is to provide a button structure having a better usage hand feeling and a touch sensing function. The button structure includes a button body, a conductive film, a circuit board, a metal elastic element and a bracket. The button body has a pressing portion. One side of an upper portion of a rear surface of the pressing portion protrudes upward to form a protruding pillar. A middle of the upper portion of the rear surface of the pressing portion extends rearward to form a triggering portion. The triggering portion is disposed beside the protruding pillar. The conductive film is disposed to an inner surface of the pressing portion, and the conductive film surrounds the protruding pillar. The circuit board is disposed to a rear of the button body. The circuit board has a switch. The switch is corresponding to the triggering portion. The metal elastic element is disposed to one side of the circuit board. One end of the metal elastic element is mounted around the protruding pillar together with the conductive film, and the one end of the metal elastic element is electrically connected with the conductive film. The other end of the metal elastic element is fastened to the circuit board, and the other end of the metal elastic element is electrically connected with the circuit board. The bracket is disposed to the rear of the button body. The circuit board is disposed on the bracket.

Another object of the present invention is to provide a button structure. The button structure includes a button body, a conductive film, a circuit board, a metal elastic element and a bracket. The button body has a pressing portion. One side of an upper portion of a rear surface of the pressing portion defines a fastening portion. A middle of the upper portion of the rear surface of the pressing portion extends rearward to form a triggering portion. The triggering portion is disposed to one side of the fastening portion. The conductive film is disposed to an inner surface of the pressing portion, and the conductive film surrounds the fastening portion. The circuit board is disposed to a rear of the button body. The circuit board has a switch. The switch is corresponding to the triggering portion. The metal elastic element is disposed to one side of the circuit board. One end of the metal elastic element is fastened to the fastening portion together with the conductive film, and the one end of the metal elastic element is electrically connected with the conductive film. The other end of the metal elastic element is fastened to the circuit board, and the other end of the metal elastic element is electrically connected with the circuit board. The bracket is disposed to the rear of the button body. The circuit board is disposed on the bracket.

Another object of the present invention is to provide a button structure disposed in a game controller. The button structure includes a button body, a conductive film, a circuit board, a metal elastic element and a bracket. The button body has a pressing portion and two stopping portions. The pressing portion has two opposite long sides and two opposite short sides. The two stopping portions are formed at the two short sides of the pressing portion, respectively. A rear surface of the pressing portion has a protruding pillar, a triggering portion and two rotating arms. The triggering portion and the two rotating arms are disposed to two rears of the two long sides of the pressing portion, respectively. The two stopping portions abut against an inside of the game controller. The conductive film is disposed to an inner surface of the pressing portion, and the conductive film surrounds the protruding pillar. The circuit board is disposed to a rear of the button body. The circuit board has a switch. The switch is corresponding to the triggering portion. The metal elastic element is disposed to one side of the circuit board. One end of the metal elastic element is mounted around the protruding pillar together with the conductive film, and the one end of the metal elastic element is electrically connected with the conductive film. The other end of the metal elastic element is fastened to the circuit board, and the other end of the metal elastic element is electrically connected with the circuit board. The bracket is disposed to the rear of the button body. The circuit board is disposed on the bracket. Several portions of a bottom surface of the bracket extend downward to form a plurality of extending portions. The two rotating arms rotatably connected to the two extending portions.

As described above, a lower portion of the rear surface of the pressing portion extends rearward to form the two rotating arms. When the pressing portion of the button body is pressed downward, the triggering portion of the button body is rotated upward by the two rotating arms to press against the switch, so the button body is without tilting. Furthermore, the fastening end of the rear end of the main portion of the metal elastic element is fastened to the top surface of the circuit board by a screw, so the circuit board and the metal elastic element contact with the conductive film, and the circuit board, the metal elastic element and the conductive film are conductive. In addition, the conductive film is adhered to an inner surface of the button body, so the button body has the touch sensing function. When a finger is placed on the button body, a corresponding game function is executed. When the button body is pressed downward, a perception of an idle stroke between the triggering portion of the button body and the switch of the circuit board is eliminated by an elastic force of the metal elastic element, correspondingly, a usage hand feeling of the button structure is improved. As a result, the button structure has the better usage hand feeling and the touch sensing function.

### BRIEF DESCRIPTION OF THE DRAWINGS

The present invention will be apparent to those skilled in the art by reading the following description, with reference to the attached drawings, in which:

FIG. 1 is a perspective view of a button structure, wherein the button structure is assembled to a game controller in accordance with a first preferred embodiment of the present invention;

FIG. 2 is an exploded view of the button structure and the game controller according to the first preferred embodiment of the present invention;

FIG. 3 is a perspective view of the button structure of FIG. 2;

FIG. 4 is an exploded view of the button structure of FIG. 3; and

FIG. 5 is an exploded view of the button structure and the game controller according to a second preferred embodiment of the present invention.

### DETAILED DESCRIPTION OF THE INVENTION

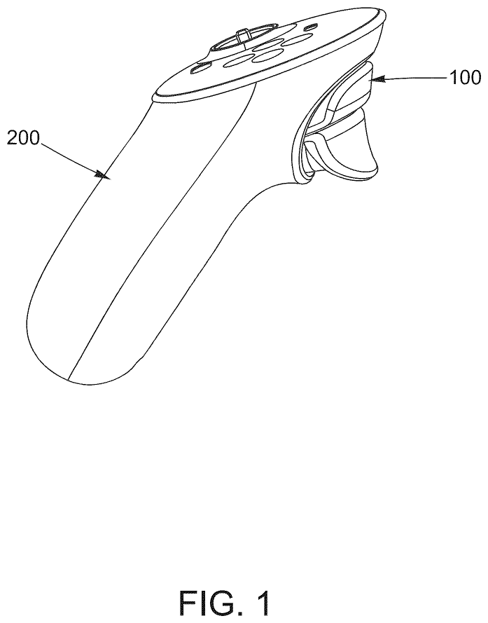

With reference to FIG. 1 to FIG. 5, a button structure 100 according to a first preferred embodiment and a second preferred embodiment of the present invention is shown. The button structure 100 is disposed in a game controller 200. The button structure 100 includes a button body 1, a conductive film 2, a circuit board 3, a metal elastic element 4 and a bracket 5.

The button body 1 is disposed to a front of the bracket 5. The bracket 5 is disposed to a rear of the button body 1. The button body 1 is disposed to a front of the circuit board 3. The circuit board 3 is disposed to the rear of the button body 1. The conductive film 2 is disposed to an inner surface of the button body 1. The conductive film 2 is adhered to the inner surface of the button body 1, so the button body 1 has a touch sensing function. In a concrete implementation, the conductive film 2 is without being limited to be adhered to the inner surface of the button body 1. The conductive film 2 is formed on the inner surface of the button body 1 by a laser engraving way, or the conductive film 2 is electroplated on the inner surface of the button body 1. The circuit board 3 is disposed on the bracket 5. The metal elastic element 4 is disposed to one side of the circuit board 3. Two opposite ends of the metal elastic element 4 are fastened to a top surface of the button body 1 together with a top surface of the conductive film 2, and a top surface of the circuit board 3, respectively. In the preferred embodiment, the metal elastic element 4 is a tension spring.

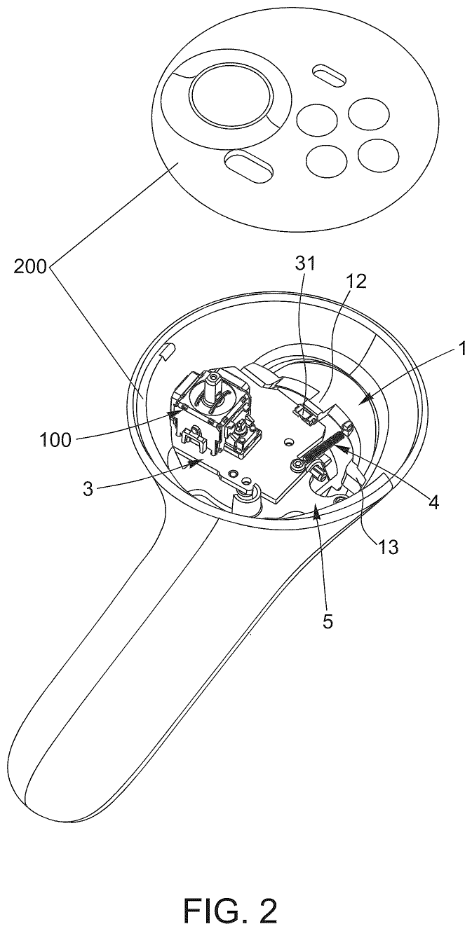

Referring to FIG. 2 to FIG. 5, in the first preferred embodiment and the second preferred embodiment, the button body 1 has a pressing portion 10, a protruding pillar 11, a triggering portion 12, two stopping portions 13, two rotating arms 14 and a plurality of pivoting holes 15. The conductive film 2 is disposed to an inner surface of the pressing portion 10. The conductive film 2 is formed on the inner surface of the pressing portion 10 of the button body 1 by the laser engraving way, or the conductive film 2 is electroplated on the inner surface of the pressing portion 10 of the button body 1. The conductive film 2 is adhered to the inner surface of the pressing portion 10. One side of an upper portion of a rear surface of the pressing portion 10 define a fastening portion 17. And the conductive film 2 surrounds the fastening portion 17. One end of the metal elastic element 4 is fastened to the fastening portion 17 together with the conductive film 2.

The pressing portion 10 has two opposite long sides 18 and two opposite short sides 19. The two stopping portions 13 are formed at the two short sides 19 of the pressing portion 10, respectively. The rear surface of the pressing portion 10 has the protruding pillar 11, the triggering portion 12 and the two rotating arms 14. The triggering portion 12 and the two rotating arms 14 are disposed to two rears of the two long sides 18 of the pressing portion 10, respectively. The two stopping portions 13 abut against an inside of the game controller 200.

In the first preferred embodiment, the one side of the upper portion of the rear surface of the pressing portion 10 protrudes upward to form the protruding pillar 11. Substantial middles of a rear and two sides of an outer surface of the protruding pillar 11 are recessed inward to form a limiting slot 111. A right of the upper portion of the rear surface of the pressing portion 10 extends upward to form the protruding pillar 11. And the conductive film 2 surrounds the protruding pillar 11, and the conductive film 2 is attached to the outer surface of the protruding pillar 11, so the protruding pillar 11 has a conductive function. The one end of the metal elastic element 4 is shown as a ring shape. The one end of the metal elastic element 4 is mounted around the protruding pillar 11 together with the conductive film 2, the one end of the metal elastic element 4 is limited in the limiting slot 111 and the one end of the metal elastic element 4 is electrically connected with the conductive film 2, so the metal elastic element 4 contacts with the conductive film 2, and the metal elastic element 4 and the conductive film 2 are mutually conductive.

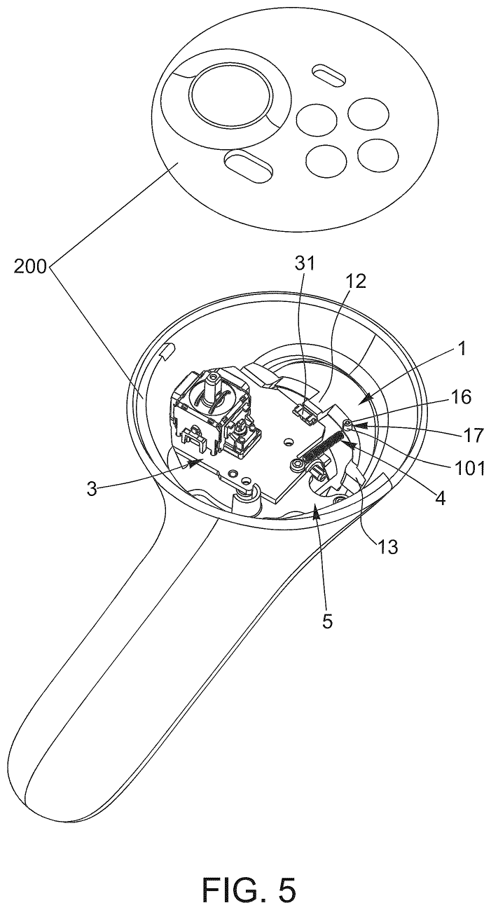

Referring to FIG. 5, differences between the button structure 100 in accordance with the second preferred embodiment and the button structure 100 in accordance with the first preferred embodiment are described as follows. The one side of the upper portion of the rear surface of the pressing portion 10 protrudes upward to form a protruding column 101. The protruding column 101 defines a penetrating hole 16 penetrating through a middle of a top surface of the protruding column 101. The one end of the metal elastic element 4 is matched with the penetrating hole 16 of the protruding column 101. The one end of the metal elastic element 4 is fastened to the penetrating hole 16.

The fastening portion 17 is the protruding pillar 11 together with the limiting slot 111 or the protruding column 101 together with the penetrating hole 16. When the fastening portion 17 is the protruding pillar 11 together with the limiting slot 111, the one end of the metal elastic element 4 is mounted around the fastening portion 17 together with the conductive film 2. When the fastening portion 17 is the protruding column 101 together with the penetrating hole 16, the one end of the metal elastic element 4 is buckled in the penetrating hole 16.

Referring to FIG. 1 to FIG. 5, a middle of the upper portion of the rear surface of the pressing portion 10 extends rearward to form the triggering portion 12. The triggering portion 12 is disposed beside the protruding pillar 11. Two opposite sides of the upper portion of the rear surface of the pressing portion 10 extend outward to form the two stopping portions 13. The two stopping portions 13 abut against an inner surface of the game controller 200. The two stopping portions 13 prevent the button body 1 moving frontward to break away from the game controller 200. The triggering portion 12 is disposed to one side of the fastening portion 17. The triggering portion 12 is disposed between the fastening portion 17 and one stopping portion 13. Specifically, the triggering portion 12 is disposed between the protruding pillar 11 and the one stopping portion 13. One side and a middle of a lower portion of the rear surface of the pressing portion 10 extend rearward to form the two rotating arms 14. The triggering portion 12 of the button body 1 is rotated upward by the two rotating arms 14 to press downward upon a corresponding mechanism of the circuit board 3.

When the button body 1 is pressed downward, the button body 1 is without being from tilting. Each rotating arm 14 has one pivoting hole 15 transversely penetrating through two side surfaces of the rotating arm 14. Specifically, each rotating arm 14 has the one pivoting hole 15 penetrating through a left surface and a right surface of the rotating arm 14. The plurality of the pivoting holes 15 are mounted around corresponding mechanisms of the bracket 5 to realize that the bracket 5 is located to the button body 1, and the button body 1 is fixed to the bracket 5. The button body 1 rotates with respect to the bracket 5.

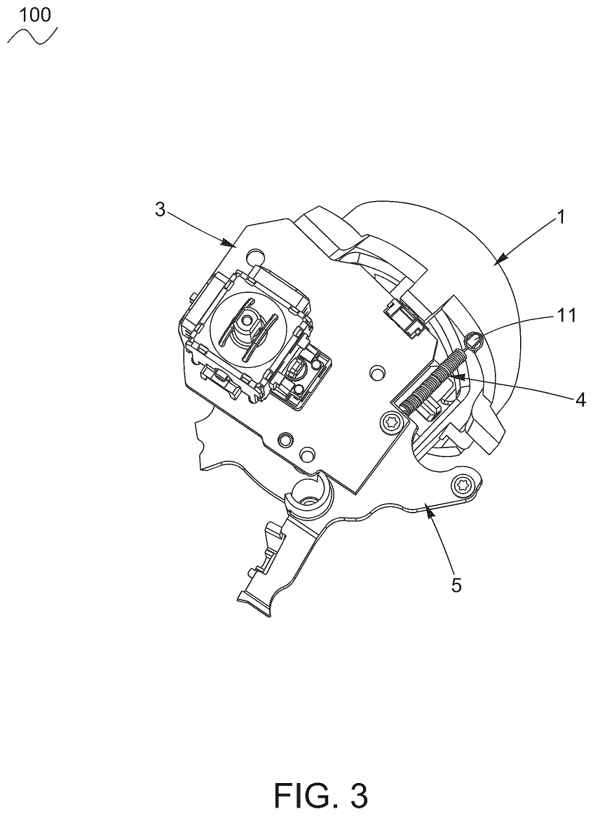

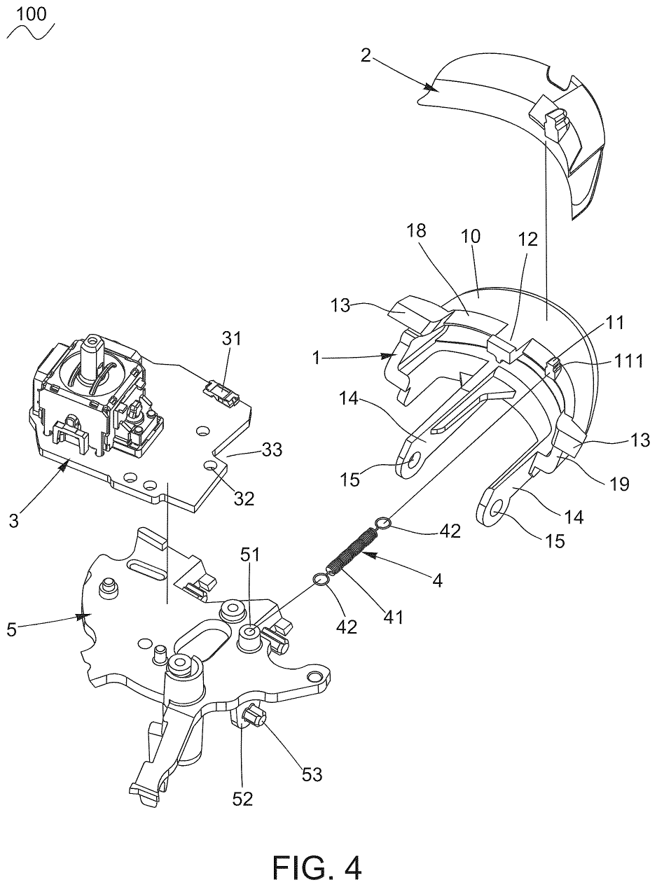

Referring to FIG. 3 and FIG. 4, the circuit board 3 has a switch 31, a conductive hole 32 and a lacking groove 33. The switch 31 is disposed on a front end of the top surface of the circuit board 3. The switch 31 is corresponding to the triggering portion 12 of the button body 1. A rear end of the triggering portion 12 of the button body 1 is corresponding to the switch 31. A distance is formed between the switch 31 and the triggering portion 12 of the button body 1. When the pressing portion 10 of the button body 1 is pressed downward, the triggering portion 12 of the button body 1 is rotated upward by the two rotating arms 14 to press against the switch 31. The triggering portion 12 of the button body 1 presses against the switch 31 to generate a triggering signal. The triggering signal is transmitted to a processor of the game controller 200, so the processor of the game controller 200 executes instructions according to the triggering signal.

The conductive hole 32 penetrates through the top surface and a bottom surface of the circuit board 3. The conductive hole 32 is corresponding to a corresponding area of the bracket 5. A screw passes through the conductive hole 32, and then the screw is locked to the corresponding area of the bracket 5 to realize that the circuit board 3 is located to the bracket 5, and the circuit board 3 is fixed to the bracket 5. One side of the circuit board 3 is recessed inward to form the lacking groove 33. The lacking groove 33 is formed in front of the conductive hole 32. The metal elastic element 4 is disposed to the lacking groove 33. The other end of the metal elastic element 4 is fastened to the conductive hole 32 of the circuit board 3 by the screw, and the other end of the metal elastic element 4 is electrically connected with the circuit board 3. The metal elastic element 4 contacts with a wall of the conductive hole 32 of the circuit board 3, and the metal elastic element 4 and the wall of the conductive hole 32 of the circuit board 3 are mutually conductive. Therefore, the conductive film 2 is electrically connected with the wall of the conductive hole 32 of the circuit board 3.

In the concrete implementation, the circuit board 3 defines a through hole penetrating through the top surface and the bottom surface of the circuit board 3. Then, a conductive material is disposed in the through hole to form the conductive hole 32. The conductive material is disposed to areas of the top surface and the bottom surface of the circuit board 3 which are around the through hole to form the conductive hole 32.

Referring to FIG. 3 and FIG. 4, the metal elastic element 4 has a main portion 41 and two fastening ends 42. The main portion 41 is disposed to the lacking groove 33. The two fastening ends 42 are formed at a front end and a rear end of the main portion 41, respectively. The fastening end 42 of the front end of the main portion 41 is mounted around the protruding pillar 11 of the button body 1. The fastening end 42 of the rear end of the main portion 41 is fastened to the top surface of the circuit board 3. The fastening end 42 of the rear end of the main portion 41 of the metal elastic element 4 is corresponding to the conductive hole 32 of the circuit board 3. In the present invention, the fastening end 42 of the rear end of the main portion 41 is locked to the top surface of the circuit board 3 by the screw. The circuit board 3 and the metal elastic element 4 contact with the conductive film 2, and the circuit board 3, the metal elastic element 4 and the conductive film 2 are conductive. The button body 1 has the touch sensing function on account of the conductive film 2 being adhered to the inner surface of the button body 1. In the second preferred embodiment, the fastening end 42 of the front end of the main portion 41 is fastened to the fastening portion 17 of the button body 1.

When a finger is placed on the button body 1, a corresponding game function is executed. When the button body 1 is pressed downward, a perception of an idle stroke between the triggering portion 12 of the button body 1 and the switch 31 of the circuit board 3 is eliminated by an elastic force of the metal elastic member 4, a usage hand feeling of the button structure 100 is improved.

Referring to FIG. 3 and FIG. 4, the bracket 5 has a locating pillar 51, a plurality of extending portions 52 and a plurality of rotating shafts 53. A top surface of the bracket 5 extends upward to form the locating pillar 51. The locating pillar 51 is corresponding to the conductive hole 32 of the circuit board 3. The fastening end 42 of the rear end of the main portion 41 of the metal elastic element 4 and the conductive hole 32 of the circuit board 3 are fastened to the locating pillar 51 by the screw. Several portions of a bottom surface of the bracket 5 extend downward to form the plurality of the extending portions 52. Each rotating arm 14 abuts against one side of each of two extending portions 52. One side of each extending portion 52 extends outward to form a rotating shaft 53. The plurality of the pivoting holes 15 are fastened to the plurality of the rotating shafts 53 of the plurality of the extending portions 52 to realize that the bracket 5 is located to the button body 1, and the button body 1 is fixed to the bracket 5. The button body 1 rotates with respect to the bracket 5.

As described above, the lower portion of the rear surface of the pressing portion 10 extends rearward to form the two rotating arms 14. When the pressing portion 10 of the button body 1 is pressed downward, the triggering portion 12 of the button body 1 is rotated upward by the two rotating arms 14 to press against the switch 31, so the button body 1 is without tilting. Furthermore, the fastening end 42 of the rear end of the main portion 41 of the metal elastic element 4 is fastened to the top surface of the circuit board 3 by the screw, so the circuit board 3 and the metal elastic element 4 contact with the conductive film 2, and the circuit board 3, the metal elastic element 4 and the conductive film 2 are conductive. In addition, the conductive film 2 is adhered to the inner surface of the button body 1, so the button body 1 has the touch sensing function. When the finger is placed on the button body 1, the corresponding game function is executed. When the button body 1 is pressed downward, the perception of the idle stroke between the triggering portion 12 of the button body 1 and the switch 31 of the circuit board 3 is eliminated by the elastic force of the metal elastic element 4, correspondingly, the usage hand feeling of the button structure 100 is improved. As a result, the button structure 100 has the better usage hand feeling and the touch sensing function.

What is claimed is:

1. A button structure, comprising:
a button body having a pressing portion, one side of an upper portion of a rear surface of the pressing portion protruding upward to form a protruding pillar, a middle of the upper portion of the rear surface of the pressing portion extending rearward to form a triggering portion, the triggering portion being disposed beside the protruding pillar;
a conductive film disposed to an inner surface of the pressing portion, and the conductive film surrounding the protruding pillar;
a circuit board disposed to a rear of the button body, the circuit board having a switch, the switch being corresponding to the triggering portion;
a metal elastic element disposed to one side of the circuit board, one end of the metal elastic element being mounted around the protruding pillar together with the conductive film, and the one end of the metal elastic element being electrically connected with the conductive film, the other end of the metal elastic element being fastened to the circuit board, and the other end of the metal elastic element being electrically connected with the circuit board; and
a bracket disposed to the rear of the button body, the circuit board being disposed on the bracket.

2. The button structure as claimed in claim 1, wherein one side of the circuit board is recessed inward to form a lacking groove, the metal elastic element has a main portion and two fastening ends, the main portion is disposed to the lacking groove, the two fastening ends are formed at a front end and a rear end of the main portion, respectively, the fastening end of the front end of the main portion is mounted around the protruding pillar of the button body, the fastening end of the rear end of the main portion is fastened to a top surface of the circuit board.

3. The button structure as claimed in claim 2, wherein the circuit board has a conductive hole penetrating through the top surface and a bottom surface of the circuit board, the lacking groove is formed in front of the conductive hole, the fastening end of the rear end of the main portion of the metal elastic element is corresponding to the conductive hole, a top surface of the bracket extends upward to form a locating pillar, the locating pillar is corresponding to the conductive hole.

4. The button structure as claimed in claim 1, wherein one side and a middle of a lower portion of the rear surface of the pressing portion extend rearward to form two rotating arms, several portions of a bottom surface of the bracket extend downward to form a plurality of extending portions, each rotating arm abuts against one side of each of two extending portions.

5. The button structure as claimed in claim 4, wherein the button body has a plurality of pivoting holes, each rotating arm has one pivoting hole transversely penetrating through two side surfaces of the rotating arm, one side of each extending portion extends outward to form a rotating shaft, the plurality of the pivoting holes are fastened to the plurality of the rotating shafts of the plurality of the extending portions.

6. The button structure as claimed in claim 1, wherein the conductive film is formed on the inner surface of the pressing portion of the button body by a laser engraving.

7. The button structure as claimed in claim 1, wherein the conductive film is adhered to the inner surface of the pressing portion.

8. The button structure as claimed in claim 1, wherein the conductive film is electroplated on the inner surface of the pressing portion of the button body.

9. The button structure as claimed in claim 1, wherein the one end of the metal elastic element is shown as a ring shape.

10. A button structure, comprising:
a button body having a pressing portion, one side of an upper portion of a rear surface of the pressing portion defining a fastening portion, a middle of the upper portion of the rear surface of the pressing portion extending rearward to form a triggering portion, the triggering portion being disposed to one side of the fastening portion;
a conductive film disposed to an inner surface of the pressing portion, and the conductive film surrounding the fastening portion;
a circuit board disposed to a rear of the button body, the circuit board having a switch, the switch being corresponding to the triggering portion;
a metal elastic element disposed to one side of the circuit board, one end of the metal elastic element being fastened to the fastening portion together with the conductive film, and the one end of the metal elastic element being electrically connected with the conductive film, the other end of the metal elastic element being fastened to the circuit board, and the other end of the metal elastic element being electrically connected with the circuit board; and
a bracket disposed to the rear of the button body, the circuit board being disposed on the bracket.

11. The button structure as claimed in claim 10, wherein one side of the circuit board is recessed inward to form a lacking groove, the metal elastic element has a main portion and two fastening ends, the main portion is disposed to the lacking groove, the two fastening ends are formed at a front end and a rear end of the main portion, respectively, the fastening end of the front end of the main portion is fastened to the fastening portion of the button body, the fastening end of the rear end of the main portion is fastened to a top surface of the circuit board.

12. The button structure as claimed in claim 11, wherein the circuit board has a conductive hole penetrating through the top surface and a bottom surface of the circuit board, the lacking groove is formed in front of the conductive hole, the fastening end of the rear end of the main portion is corresponding to the conductive hole, a top surface of the bracket extends upward to form a locating pillar, the locating pillar is corresponding to the conductive hole.

13. The button structure as claimed in claim 10, wherein one side and a middle of a lower portion of the rear surface of the pressing portion extend rearward to form two rotating arms, several portions of a bottom surface of the bracket extend downward to form a plurality of extending portions, each rotating arm abuts against one side of each of two extending portions.

14. The button structure as claimed in claim 13, wherein the button body has a plurality of pivoting holes, each rotating arm has one pivoting hole transversely penetrating through two side surfaces of the rotating arm, one side of each extending portion extends outward to form a rotating shaft, the plurality of the pivoting holes are fastened to the plurality of the rotating shafts of the plurality of the extending portions.

15. The button structure as claimed in claim 10, wherein the conductive film is formed on the inner surface of the pressing portion of the button body by a laser engraving.

16. The button structure as claimed in claim 10, wherein the conductive film is electroplated on the inner surface of the pressing portion of the button body.

17. The button structure as claimed in claim 10, wherein the one side of the upper portion of the rear surface of the pressing portion protrudes upward to form a protruding column, the protruding column defines a penetrating hole penetrating through a middle of a top surface of the protruding column, the one end of the metal elastic element is matched with the penetrating hole of the protruding column, the one end of the metal elastic element is fastened to the penetrating hole, the fastening portion is the protruding column together with the penetrating hole.

18. The button structure as claimed in claim 10, wherein the one side of the upper portion of the rear surface of the pressing portion protrudes upward to form a protruding pillar, substantial middles of a rear and two sides of an outer surface of the protruding pillar are recessed inward to form a limiting slot, the one end of the metal elastic element is mounted around the protruding pillar together with the conductive film, the one end of the metal elastic element is limited in the limiting slot.

19. A button structure disposed in a game controller, comprising:
a button body having a pressing portion and two stopping portions, the pressing portion having two opposite long sides and two opposite short sides, the two stopping portions being formed at the two short sides of the pressing portion, respectively, a rear surface of the pressing portion having a protruding pillar, a triggering portion and two rotating arms, the triggering portion and the two rotating arms being disposed to two rears of the two long sides of the pressing portion, respectively, the two stopping portions abutting against an inside of the game controller;
a conductive film disposed to an inner surface of the pressing portion, and the conductive film surrounding the protruding pillar;
a circuit board disposed to a rear of the button body, the circuit board having a switch, the switch being corresponding to the triggering portion;
a metal elastic element disposed to one side of the circuit board, one end of the metal elastic element being mounted around the protruding pillar together with the conductive film, and the one end of the metal elastic element being electrically connected with the conductive film, the other end of the metal elastic element being fastened to the circuit board, and the other end of the metal elastic element being electrically connected with the circuit board; and
a bracket disposed to the rear of the button body, the circuit board being disposed on the bracket, several portions of a bottom surface of the bracket extending downward to form a plurality of extending portions, the two rotating arms rotatably connected to the two extending portions.
